(19) United States
(12) Patent Application Publication
(10) Pub. No.: US 2024/0351142 A1
(43) Pub. Date: Oct. 24, 2024

(54) METHOD FOR LASER-CUTTING AND POST-TREATING UTG HAVING PARTIAL COATING FILM FORMED THEREON

(71) Applicant: DOWOOINSYS CO.,LTD., Cheongju-si (KR)

(72) Inventors: Seung Jun YI, Suwon-si (KR); Hyung Sup LEE, Yongin-si (KR); Sun Hong CHOI, Yongin-si (KR); Soung Woong CHOI, Cheongju-si (KR)

(21) Appl. No.: 18/683,997

(22) PCT Filed: Jan. 13, 2022
(86) PCT No.: PCT/KR2022/000596

§ 371 Date: Feb. 15, 2024

(30) Foreign Application Priority Data
Dec. 30, 2021 (KR) 10-2021-0192436

(51) Int. Cl. B23K 26/362; B23K 26/60; B23K 26/70; B23K 103/00

(52) U.S. Cl. CPC B23K 26/362; B23K 26/60; B23K 26/70; B23K 2103/54

(57) ABSTRACT

A method for laser-cutting and post-treating a UTG having a partial coating film formed thereon according to the present invention includes a step (S1) of coating an entire front surface of a thin-film mother glass (1) with a coating solution for preventing chemical contact, and then drying the resulting product to form a coating film, a step (S2) of forming, on a rear surface of the thin-film mother glass (1), a partial coating film (2) which is the same shape as the shape of a cell-unit thin-film glass (3) to be cut from the thin-film mother glass (1), and a step (S3) of irradiating the rear surface of the thin-film mother glass (1) with a laser beam to cut the coating film, formed on a front surface of the thin-film mother glass (1), and the thin-film mother glass (1), wherein the laser beam is applied along a cut guiding line (6) formed a predetermined distance away from an outer edge line of the partial coating film (2) and in the shape of the cell-unit thin-film glass (3), to cut and then separate the cell-unit thin-film glass (3) from the thin-film mother glass (1).

### TECHNICAL FIELD

The present invention relates to a method for processing a UTG having a partial coating film formed thereon, and more particularly, to a method for cutting a thin-film mother glass in which one side is fully coated with an acid-resistant coating film, and the other side is partially coated in the shape of a cell-unit thin-film glass, with an infrared laser, and then post-treating the thin-film mother glass.

### BACKGROUND ART

Thin-film glass is serving as a replacement for typical glass or acrylic these days with electronic products such as smartphones being slimmer.

The thin-film glass is used as a display window for portable electronic products such as mobile phones, PMPs, and MP3 players, and the fact that the thin-film glass gets slimmer brings about a competitive edge on design and portability.

To produce a cell-unit thin-film glass applied to various electronic products, a thin-film mother glass is cut to a certain size.

In this case, micro cracks or micro chippings resulting from cutting cause degradation in the strength of the cut cell-unit thin-film glass, and to make this degradation to the minimum, additional face milling and chamfering processes are performed.

However, in this process, the thin-film mother glass is very thin, and thus there is a risk of breakage during the face milling and chamfering processes, and face milling and chamfering each of the cell-unit thin-film glass applied to products resulted in a lot of loss in labor and time.

A method for bonding and stacking the thin-film mother glass and then processing the resulting product as a single body includes a first embodiment in which CNC is used for processing, and a second embodiment in which a laser beam is used for processing, and a detailed description of the first embodiment is as follows.

First, the first embodiment is broadly divided into the following steps: stacking two or more thin-film mother glasses and applying a resin for maintaining a height gap between the two or more thin-film mother glasses based on a preset pattern, cutting the stack of two or more thin-film mother glasses using CNC processing to cut cell-unit thin-film glasses applied to various electrical and electronic products from the thin-film mother glasses, smoothing the cutting surface of the cell-unit thin-film glass through chemical healing of the stack of multiple cell-unit thin-film glasses, cleaning the healed cell-unit thin-film glasses, completely curing the resin applied between the cell-unit thin-film glass and the cell-unit thin-film glass for easy separation, separating the resin bonded between the cell-unit thin-film glass and the cell-unit thin-film glass, cleaning the cell-unit thin-film glass from which the resin is removed, chemically healing the cleaned cell-unit thin-film glass, and cleaning the chemically healed cell-unit thin-film glass, reinforcing the cleaned cell-unit thin-film glass, and then exporting the reinforced cell-unit thin-film glass to a subsequent process.

The step of stacking two or more thin-film mother glasses and applying a resin for maintaining a height gap between the two or more thin-film mother glasses based on a preset pattern includes a step 1-1 of applying a resin onto an upper surface of the thin-film mother glass, a step 1-2 of stacking the thin-film mother glass on the applied resin and then spreading the resin thinly, a step 1-3 of UV curing the thinly spread resin, and repeating the steps 1-1 to 1-3 to stack two or more thin-film mother glasses.

However, in the case of the first embodiment above, the process of stacking two or more thin-film mother glasses using a resin, the CNC cutting process including rough cutting, semi-finishing cutting, and finishing cutting processes to cut the stacked thin-film mother glasses into cell-unit thin-film glasses, the process of smoothing the cutting surface of the cell-unit thin-film glass through chemical healing of the stacked cell-unit thin-film glasses, the process of completely curing the resin to facilitate separation of the stacked cell-unit thin-film glasses, the process of separating the resin and then cleaning the cell-unit thin-film glasses, and the process of chemically healing and then cleaning the cell-unit thin-film glasses cause the production of cell-unit thin-film glasses to be time-consuming and increase the production costs of cell-unit thin-film glasses.

Then, a detailed description of the second embodiment is as follows.

The second embodiment whose processing is performed using the laser beam is broadly divided into the following steps: a step of applying a laser beam along a cutting line of a thin-film mother glass to cut the thin-film mother glass so as to cut a cell-unit thin-film glass from the thin-film mother glass, a second step of stacking two or more cut cell-unit thin-film glasses and applying a resin for height spacing between the cell-unit thin-film glasses disposed above and below, a third step of smoothing the cutting surface of the cut cell-unit thin-film glass through chemical healing of the stack of two or more cell-unit thin-film glasses, a fourth step of cleaning the stacked cell-unit thin-film glasses, a fifth step of completely curing the resin applied between the cell-unit thin-film glass and the cell-unit thin-film glass which are stacked in plurality to facilitate separation, a sixth step of separating the resin attached to the cell-unit thin-film glasses and then cleaning the separated cell-unit thin-film glass individually, a seventh step of chemically healing the cleaned cell-unit thin-film glass, and a eighth step of cleaning the chemically healed cell-unit thin-film glass, and then reinforcing the cleaned cell-unit glass, thin-film and exporting the reinforced cell-unit thin-film glass to a subsequent process.

In addition, the second step of stacking two or more cut cell-unit thin-film glasses and applying a resin for height spacing between the cell-unit thin-film glasses disposed above and below includes a step 2-1 of stacking two or more of the cut cell-unit thin-film glasses and applying a resin for height spacing between a pair of cell-unit thin-film glasses disposed above and below, a step 2-2 of stacking the cell-unit thin-film glasses on the applied resin and then spreading the resin thinly, a step 2-3 of UV curing the flat-spread resin, and a step of repeating steps 2-1 to 2-3 to stack two or more cut cell-unit thin-film glasses.

However, in the method of using the laser beam, the process of stacking two or more cut cell-unit thin-film glasses using a resin, the process of completely curing the resin applied between the stacked cell-unit thin-film glasses, and the process of separating the resin and separating the cell-unit thin-film glasses make the production of cell-unit thin-film glasses time-consuming and increase the production costs of cell-unit thin-film glasses.

In addition, in the case of glass cutting using CNC, defects such as micro cracks or micro chippings are generated on the cutting surface, and in the case of glass cutting and coating film removal using a laser, heat damage is caused in the portions irradiated with a laser, resulting in easy breakage of the cell-unit thin-film glasses.

Such micro-cracks or micro-chipping defects caused by CNC or heat damage caused by lasers may cause degradation in flexural strength even after reinforcing the cell-unit thin-film glasses.

As in the first and second embodiments, a method of stacking cell-unit thin-film glasses in multiple layers using a resin and then chemically treating the cut surface to heal portions of defects or heat damage caused upon glass cutting is used as a method mainly used to compensate for weakened portions of the CNC or laser cutting surface.

However, the cutting surface treatment method also has limitations, and thus a method to minimize damage to the thin-film glass when cutting the thin-film glass using the CNC process or the laser process needs to be secured, but when the method is secured, the process margin becomes smaller and processing the cell-unit thin-film glass applied to various electrical and electronic products takes a long time, and when the surface treatment process is additionally performed, the manufacturing process of cell-unit thin-film glass becomes very complicated, which may cause an increase in costs of manufacturing products.

Meanwhile, as a related art to the present invention, “efficient method for processing thin glass” under application No. “10-2010-0026394” has been applied for and disclosed, and the efficient method for processing a thin glass includes a process of applying a bonding material between stacked glass plates to bond the glass plates and cutting the bonded glass plates collectively into blocks, a process of face milling a thin plate material in block units, and a process of polishing the cut cross-section using the rotational force of a brush and an abrasive.

However, the efficient method for processing a thin glass had a limitation in that micro-cracks or micro-chipping defects were not completely removed from the cutting cross-section of the thin glass due to the face milling process and the polishing process.

### DISCLOSURE OF THE INVENTION

### Technical Problem

To prevent the issues described above, the present invention provides a method for processing a UTG having a partial coating film formed thereon, which may reduce production costs for a glass-cutting process and a post-treating process performed in the manufacture of a cell-unit thin-film glass (UTG: Ultra-Thin Glass) applied to various electrical and electronic products.

The present invention also provides a method for processing a UTG having a partial coating film formed thereon, which may reduce the manufacturing costs of a cell-unit thin-film glass through a simplified manufacturing process in the manufacture of the cell-unit thin-film glass.

The present invention also provides a method for processing a UTG having a partial coating film formed thereon, which may improve the durability of a processed cell-unit thin-film glass by removing heat-damaged portions around a glass cutting surface, which are caused by a laser beam when cutting glass using a laser and removing a coating film, through selective chemical treatment.

### Technical Solution

To achieve the objectives described above, a method for processing a UTG having a partial coating film formed thereon according to the present invention includes a step (S1) of coating an entire front surface of a thin-film mother glass (1) with a coating solution for preventing chemical contact, and then drying the resulting product to form a coating film, a step (S2) of forming, on a rear surface of the thin-film mother glass (1), a partial coating film (2) which is the same shape as the shape of a cell-unit thin-film glass (3) to be cut from the thin-film mother glass (1), and a step (S3) of irradiating the rear surface of the thin-film mother glass (1) with a laser beam to cut the coating film, formed on a front surface of the thin-film mother glass (1), and the thin-film mother glass (1), wherein the laser beam is applied along a cut guiding line (6) formed a predetermined distance away from an outer edge line of the partial coating film (2) and in the shape of the cell-unit thin-film glass (3), to cut and then separate the cell-unit thin-film glass (3) from the thin-film mother glass (1).

The cut guiding line (6) is 1 um to 100 um away from the outer edge line of the partial coating film (2), the coating solution used to form the coating film formed on the front surface of the thin-film mother glass (1) and the partial coating film (2) formed on the rear surface is an acid-resistant coating solution, and the laser beam is a laser beam output from an infrared laser (4).

### Advantageous Effects

A method for processing a UTG having a partial coating film formed thereon according to the present invention consisting of these steps may reduce production costs for a glass-cutting process and a post-treating process performed in the manufacture of a cell-unit thin-film glass (UTG: Ultra-Thin Glass) applied to various electrical and electronic products.

In addition, the present invention may reduce the manufacturing costs of a cell-unit thin-film glass through a simplified manufacturing process in the manufacture of the cell-unit thin-film glass and may improve the durability of a processed cell-unit thin-film glass by removing heat-damaged portions around a glass cutting surface, which are caused by a laser beam when cutting glass using a laser and removing a coating film, through selective chemical treatment.

### BRIEF DESCRIPTION OF THE DRAWINGS

FIG. 1 is a control block diagram of the present invention;

FIG. 2 is a longitudinal sectional view of a thin-film mother glass in which a coating film is formed on an entire front surface and a partial coating film is formed on a rear surface;

FIG. 3 is a rear view of a thin-film mother glass having a partial coating film formed on a rear surface thereof;

FIG. 4 is a view for describing a cut guiding line; and

FIG. 5 is a view showing an inclined plane-shaped cut portion formed at the right-angled corner of a cell-unit thin-film glass facing a coating film when healing the cut cell-unit thin-film glass.

### DESCRIPTION OF SYMBOLS

1. Thin-film mother glass
2. Partial coating film
3. Cell-unit thin-film glass
4. Infrared laser
5. Inclined plane-shaped cut portion
6. Cut guiding line

### MODE FOR CARRYING OUT THE INVENTION

Hereinafter, the present invention will be described in detail with reference to the accompanying drawings.

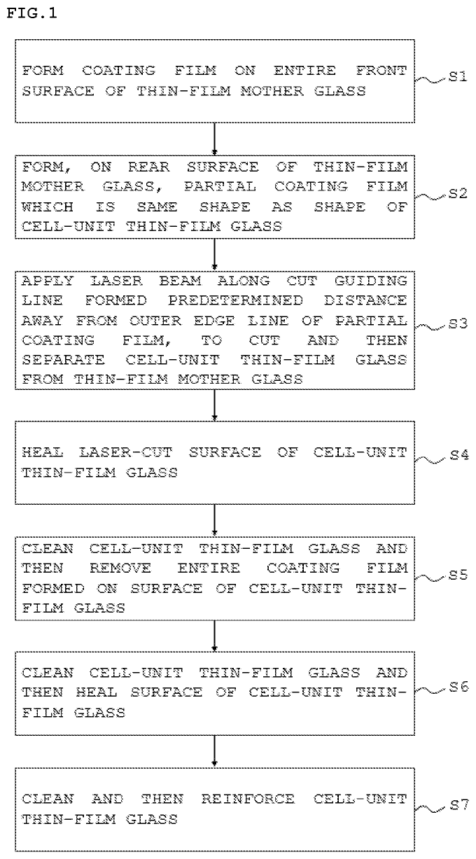

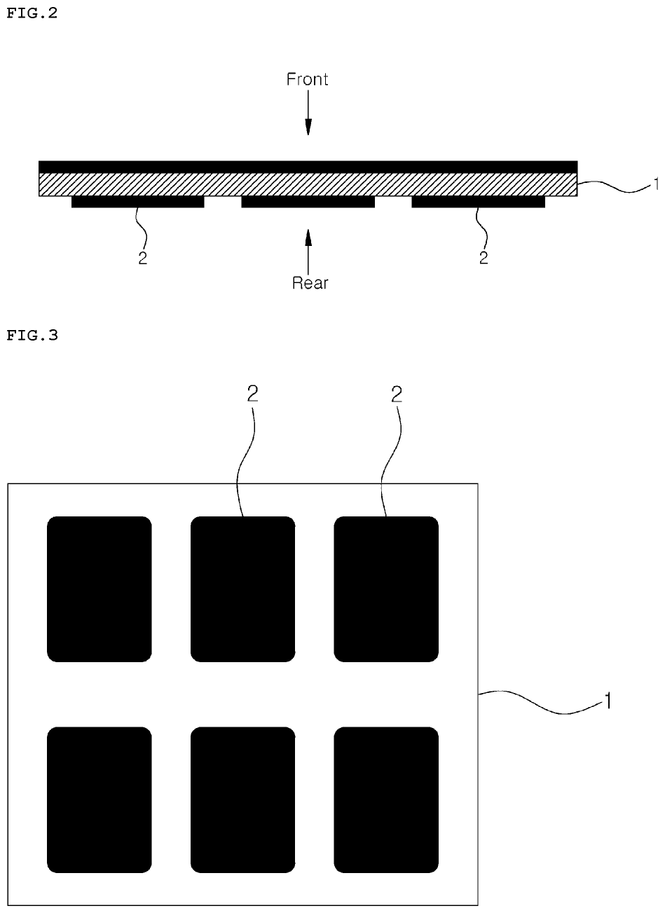

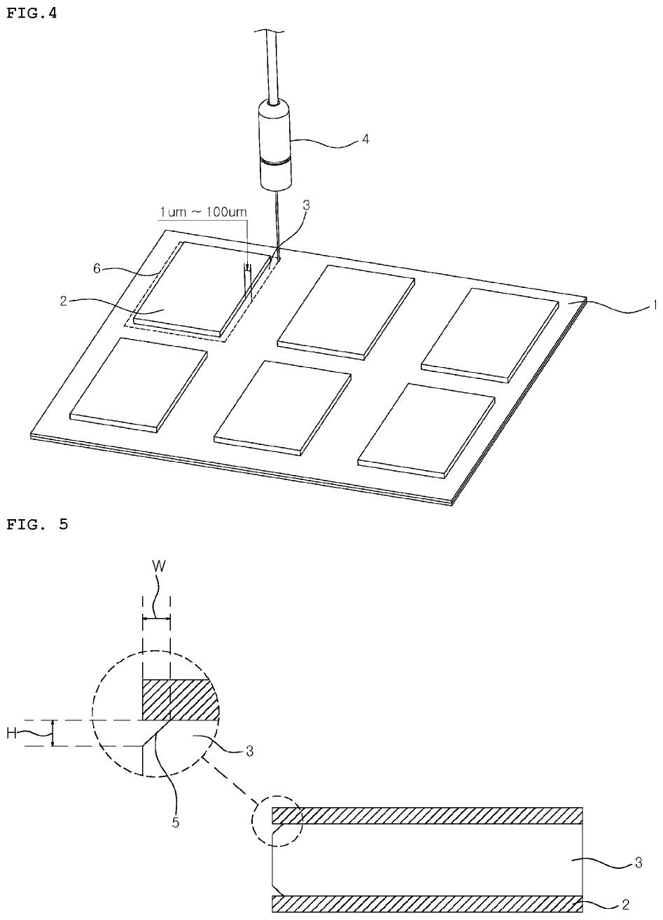

As shown in FIGS. 1 to 4, a method for processing a UTG having a partial coating film formed thereon according to the present invention includes a step (S1) of coating an entire front surface of a thin-film mother glass (1) with a coating solution for preventing chemical contact, and then drying the resulting product to form a coating film, a step (S2) of forming, on a rear surface of the thin-film mother glass (1), a partial coating film (2) which is the same shape as the shape of a cell-unit thin-film glass (3) to be cut from the thin-film mother glass (1), and a step (S3) of irradiating the rear surface of the thin-film mother glass (1) with a laser beam to cut the coating film, formed on a front surface of the thin-film mother glass (1), and the thin-film mother glass (1), wherein the laser beam is applied along a cut guiding line (6) formed a predetermined distance away from an outer edge line of the partial coating film (2) and in the shape of the cell-unit thin-film glass (3), to cut and then separate the cell-unit thin-film glass (3) from the thin-film mother glass (1).

The thin-film mother glass (1) is a thin-film glass in an original state (1) before extracting the cell-unit thin-film glass (3) from the thin-film mother glass (1) and is also called a mother glass.

The cell-unit thin-film glass (3) is a thin-film cut and separated from the thin-film mother glass (1).

In addition, as shown in FIG. 1, the present invention further includes a step (S4) of healing a laser-cut surface of the cell-unit thin-film glass (3) through selective chemical treatment of the cut cell-unit thin-film glass (3) to remove heat-damaged and defect portions around the cut surface of the cell-unit thin-film glass (3) generated during the laser cutting process, a step (S5) of cleaning the cell-unit thin-film glass (3) and then removing the entire coating film formed on the surface of the cell-unit thin-film glass (3), and a step (S6) of cleaning the cell-unit thin-film glass (3) from which the coating film is entirely removed and then chemically healing the surface of the cell-unit thin-film glass (3) to remove defects or flaws on the surface of the cell-unit thin-film glass (3) from which the coating film is entirely removed.

The cut guiding line (6) is preferably 1 um to 100 um away from the outer edge line of the partial coating film (2).

The thin-film mother glass (1) and the cell-unit thin-film glass (3) have a thickness of 100 um or less.

The coating film formed on either side of the thin-film mother glass (1) has a thickness of less than 30 um.

The thin-film mother glass (1) is an alkali alumino-silicate (sodium alumino-silicate glass)-based glass.

In addition, as shown in FIG. 1, the present invention further includes a step (S7) of cleaning the cell-unit thin-film glass (3) on which the surface healing is completed and then reinforcing the cell-unit thin-film glass (3).

The laser beam is a laser beam output from an infrared laser (4), and the laser beam output from the infrared laser (4) generates a wavelength of 1000 nm or greater.

The infrared laser (4) is a nanosecond infrared laser (4), a picosecond infrared laser (4), or a femtosecond infrared laser (4), and the infrared laser (4) outputs a Bessel beam.

The infrared laser (4) that outputs the Bessel beam has a laser beam wavelength of 1020 nm to 1040 nm and a laser beam size of 0.8 um to 1.8 um, and the laser beam has a pulse duration of 3 ps to 12 ps.

In addition, the laser beam has a pulse repetition rate of 190 khz to 210 khz, and a pulse energy of 3 uJ to 42 uJ.

The coating solution used to form the coating film formed on the front surface of the thin-film mother glass (1) and the partial coating film (2) formed on the rear surface is, as an acid-resistant coating solution, an acrylic solution or a solution of polyethylene resin, polypropylene resin, polyvinyl chloride resin, or polystyrene resin with an ultraviolet absorption rate of 10% or greater in an ultraviolet wavelength range of 400 nm or less, and a solution with an infrared absorption rate of 1% or less in an infrared wavelength range of 1000 nm or greater.

When coating the coating solution on the front surface or the rear surface of the thin-film mother glass (1), a slot die coating method, a spray coating method, an inkjet coating method, a When coating the coating liquid on the front or back of the raw thin-film glass 1, slot die coating method, spray coating method, inkjet coating method, a barcoding method, a screen print pattern printing method, and a slit coater pattern split printing method may be used.

The coating solution may be dried using an infrared lamp, a hot air generator, a hot plate, an oven, and the like, and a cluster-type drying device or an inline-type drying device is used.

In the step (S4) of healing a laser-cut surface of the cell-unit thin-film glass (3) through selective chemical treatment of the cut cell-unit thin-film glass (3) to remove heat-damaged and defect portions around the cut surface of the cell-unit thin-film glass (3) generated during the laser cutting process, as shown in FIG. 5, an inclined plane-shaped cut portion (5) is formed by a healing solution at the right-angled corner of the cell-unit thin-film glass (3) facing the coating film formed on the front and rear surfaces of the cell-unit thin-film glass (3), the inclined plane-shaped cut portion (5) has a horizontal width (W) of 3 um to 500 um, and the inclined plane-shaped cut portion (5) has a height (H) of 3 um or greater, and the height is not greater than 50% of the thickness of the cell-unit thin-film glass (3).

The cell-unit thin-film glass (3) is dipped in a healing solution to be healed, and the healing solution includes ammonium difluoride, sulfuric acid, nitric acid, water, and an additive.

The additive is a surfactant used to improve healing performance, and the surfactant serves to lower surface tension to increase the uniformity of healing.

The healing solution includes ammonium difluoride in an amount of 0.5 wt % to 0.9 wt %, sulfuric acid in an amount of 3 wt % to 15 wt %, nitric acid in an amount of 1 wt % to 10 wt %, water in an amount of 80 wt % to 90 wt %, and additive in an amount of 0.01 wt % to 0.1 wt %.

The surfactant may be a compound represented by Formula 1 below:

R₁-OSO₃⁻HA⁺ [Formula 1]

In Formula 1 above,
R₁ is 4, 8, 12-tripropylpentadecane, and
A is triethanolamine.

In the step (S5) of cleaning the cell-unit thin-film glass (3) and then removing the entire coating film formed on the surface of the cell-unit thin-film glass (3), the cell-unit thin-film glass (3) coated with the coating film is immersed in a coating film removal solution to melt and remove the coating film.

The coating film removal solution is potassium hydroxide (KOH) as a basic aqueous solution, and the potassium hydroxide (KOH) has a temperature of 25° C. or greater.

However, an additional cleaning process may be performed after the removal of the coating film to remove traces of the coating film, which are present on the surface of the cell-unit thin-film glass (3) due to the attachment of some of the coating film.

In the step (S7) of cleaning the cell-unit thin-film glass (3) on which the surface healing is completed and then reinforcing the cell-unit thin-film glass (3), the cleaning solution for the cell-unit thin-film glass (3) on which the surface healing is completed includes a solution of potassium hydroxide (KOH) or sodium hydroxide (NaOH), and pure deionized water with a surfactant added, and the cleaning solution has a PH of 10 or greater.

In the step (S7) of cleaning the cell-unit thin-film glass (3) on which the surface healing is completed and then reinforcing the cell-unit thin-film glass (3), the reinforcing solution used to reinforce the cell-unit thin-film glass (3) is a potassium nitrate melt.

The step (S7) of cleaning the cell-unit thin-film glass (3) on which the surface healing is completed and then reinforcing the cell-unit thin-film glass (3) includes preheating the cleaned cell-unit thin-film glass (3) at 200° C. to 400° C., immersing the preheated cell-unit thin-film glass (3) in a reinforcing solution maintained at 370° C. to 470° C. for reinforcing, discharging the cell-unit thin-film glass (3) from the reinforcing solution and then slowly cooling the cell-unit thin-film glass (3) up to room temperature.

The method for processing a UTG having a partial coating film formed thereon according to the present invention consisting of these steps may reduce production costs for a glass-cutting process and a post-treating process performed in the manufacture of the cell-unit thin-film glass (3) (UTG: Ultra-Thin Glass) applied to various electrical and electronic products.

In addition, the present invention may reduce the manufacturing costs of the cell-unit thin-film glass (3) through a simplified manufacturing process in the manufacture of the cell-unit thin-film glass (3), and may improve the durability of a processed cell-unit thin-film glass (3) by removing heat-damaged portions around a glass cutting surface, which are caused by a laser beam when cutting glass using a laser and removing a coating film, through selective chemical treatment.

1. A method for processing a UTG having a partial coating film formed thereon, the method comprising:
a step (S1) of coating an entire front surface of a thin-film mother glass (1) with a coating solution for preventing chemical contact, and then drying the resulting product to form a coating film;
a step (S2) of forming, on a rear surface of the thin-film mother glass (1), a partial coating film (2) which is the same shape as the shape of a cell-unit thin-film glass (3) to be cut from the thin-film mother glass (1); and
a step (S3) of irradiating the rear surface of the thin-film mother glass (1) with a laser beam to cut the coating film, formed on a front surface of the thin-film mother glass (1), and the thin-film mother glass (1), wherein the laser beam is applied along a cut guiding line (6) formed a predetermined distance away from an outer edge line of the partial coating film (2) and in the shape of the cell-unit thin-film glass (3), to cut and then separate the cell-unit thin-film glass (3) from the thin-film mother glass (1),
wherein the thin-film mother glass (1) and the cell-unit thin-film glass (3) have a thickness of 100 um or less,
the coating film formed on either side of the thin-film mother glass (1) has a thickness of less than 30 um,
the cut guiding line (6) is 1 um to 100 um away from the outer edge line of the partial coating film (2),
the coating solution used to form the coating film formed on the front surface of the thin-film mother glass (1) and the partial coating film (2) formed on the rear surface is an acid-resistant coating solution,
the coating solution is an acrylic solution or a solution of polyethylene resin, polypropylene resin, polyvinyl chloride resin, or polystyrene resin with an ultraviolet absorption rate of 10% or greater in an ultraviolet wavelength range of 400 nm or less, and a solution with an infrared absorption rate of 1% or less in an infrared wavelength range of 1000 nm or greater,
the laser beam is a laser beam output from an infrared laser (4),
the infrared laser (4) is a nanosecond infrared laser (4), a picosecond infrared laser (4), or a femtosecond infrared laser (4), and the infrared laser (4) outputs a Bessel beam,
the infrared laser (4) that outputs the Bessel beam has a laser beam wavelength of 1020 nm to 1040 nm,
the method further comprises:
a step (S4) of healing a laser-cut surface of the cell-unit thin-film glass (3) through selective chemical treatment of the cut cell-unit thin-film glass (3) to remove heat-damaged and defect portions around the cut surface of the cell-unit thin-film glass (3) generated during the laser cutting process;
a step (S5) of cleaning the cell-unit thin-film glass (3) and then removing the entire coating film formed on the surface of the cell-unit thin-film glass (3); and
a step (S6) of cleaning the cell-unit thin-film glass (3) from which the coating film is entirely removed and then chemically healing the surface of the cell-unit thin-film glass (3) to remove defects or flaws on the surface of the cell-unit thin-film glass (3) from which the coating film is entirely removed,
the method further comprises a step (S7) of cleaning the cell-unit thin-film glass (3) on which the surface healing is completed and then reinforcing the cell-unit thin-film glass (3),
wherein in the step (S4) of healing a laser-cut surface of the cell-unit thin-film glass (3) through selective chemical treatment of the cut cell-unit thin-film glass (3) to remove heat-damaged and defect portions around the cut surface of the cell-unit thin-film glass (3) generated during the laser cutting process,
an inclined plane-shaped cut portion (5) is formed by a healing solution at the right-angled corner of the cell-unit thin-film glass (3) facing the coating film formed on the front and rear surfaces of the cell-unit thin-film glass (3),
the inclined plane-shaped cut portion (5) has a horizontal width (W) of 3 um to 500 um,
the inclined plane-shaped cut portion (5) has a height (H) of 3 um or greater, wherein the height is not greater than 50% of the thickness of the cell-unit thin-film glass (3),
in the step (S5) of cleaning the cell-unit thin-film glass (3) and then removing the entire coating film formed on the surface of the cell-unit thin-film glass (3),
the cell-unit thin-film glass (3) coated with the coating film is immersed in a coating film removal solution to melt and remove the coating film, wherein the coating film removal solution is potassium hydroxide (KOH) as a basic aqueous solution, and the potassium hydroxide (KOH) has a temperature of 25° C. or greater, and
in the step (S7) of cleaning the cell-unit thin-film glass (3) on which the surface healing is completed and then reinforcing the cell-unit thin-film glass (3), the cleaning solution for the cell-unit thin-film glass (3) on which the surface healing is completed includes a solution of potassium hydroxide (KOH) or sodium hydroxide (NaOH), and pure deionized water with a surfactant added, and the cleaning solution has a PH of 10 or greater.

2. (canceled)

3. (canceled)

4. (canceled)
